(19) United States
(12) Patent Application Publication
(10) Pub. No.: US 2013/0300723 A1
(43) Pub. Date: Nov. 14, 2013

(54) PANEL CONTROL DEVICE AND OPERATION METHOD THEREOF

(71) Applicant: Tung-Ying Wu, Tainan City (TW)

(72) Inventor: Tung-Ying Wu, Tainan City (TW)

(73) Assignee: HIMAX TECHNOLOGIES LIMITED, Tainan City (TW)

(21) Appl. No.: 13/467,364

(22) Filed: May 9, 2012

(51) Int. Cl. G09G 5/00

(52) U.S. Cl. 345/212

(57) ABSTRACT

A panel control device includes a scalar and a timing controller. The scalar transmits an image data for forming a display image. The scalar keeps the timing controller in a normal display mode or switches the timing controller to a self-refresh mode according to a state of the display image. The timing controller includes a memory and a self-refresh unit, wherein when the timing controller switches to the self-refresh mode, the self-refresh unit performs a compression procedure to progressively compress the image data and generate a plurality of first interval data accordingly. When the compression procedure ends, the self-refresh unit stores one of the plurality of first interval data to the memory as a compression data, and the timing controller continuously outputs the compression data from the memory.

### BACKGROUND OF THE INVENTION

1. Field of the Invention

The invention relates to a panel control device and an operation method thereof, and more particularly to a panel control device using a progressive compression technique to reduce image quality differences of a display image when an operation mode switches and to an operation method thereof.

2. Description of Related Art

In a general display device, a panel control device transmits an image data to a timing controller through a scalar. In addition, the timing controller outputs the image data to the display panel, so that the display panel presents a corresponding display image. In general, the scalar keeps transmitting the image data to the timing controller no matter the display image is static or not. In other words, even when the display image is static, the scalar still keeps transmitting the same image data. However, such operation method is unnecessary and also causes wasteful power consumption.

Therefore, a Panel Self Refresh (PSR) technique is proposed. In the Panel Self Refresh technique, the panel control device is used to further judge whether the current display image is static. When the current display image is static, the timing controller enters a self-refresh mode and switches from a state in which it outputs the image data to a state in which it outputs a compression data stored in a memory. In this way, the scalar stops transmitting the image data, and power consumption is thereby reduced.

However, when the operation mode of the timing controller switches from a normal display mode to the self-refresh mode, the display image of the display panel switches from an image corresponding to the image data to an image corresponding to the compression data, which causes a display quality of the display image to deteriorate suddenly. In addition, when the compression rate of the image data is higher, the phenomenon is more obvious, and users are more likely to spot the differences of the image quality. Therefore, users' comfort of watching is influenced.

### SUMMARY OF THE INVENTION

The invention is directed to a panel control device that progressively compresses an image data and outputs corresponding first interval data when an operation mode switches to a self-refresh mode. In this way, when the operation mode switches, image quality differences of display images are reduced.

The invention is directed to an operation method of a panel control device that progressively compresses an image data and outputs corresponding first interval data when an operation mode switches to a self-refresh mode. In this way, when the operation mode switches, image quality differences of display images are reduced.

The invention provides a panel control device including a scalar and a timing controller. The scalar transmits an image data for forming a display image. The scalar keeps the timing controller in a normal display mode or switches the timing controller to a self-refresh mode according to a state of the display image, and the timing controller includes a memory and a self-refresh unit. Herein, when the timing controller switches to the self-refresh mode, the self-refresh unit performs a compression procedure to progressively compress the image data and generate a plurality of first interval data accordingly, and the timing controller outputs the plurality of first interval data sequentially, wherein when the compression procedure ends, the self-refresh unit stores one of the plurality of first interval data to the memory as a compression data, and the timing controller outputs the compression data from the memory continuously.

In an embodiment of the invention, the scalar decides whether to switch the timing controller from the self-refresh mode to the normal display mode according to the state of the display image.

In an embodiment of the invention, when the timing controller switches from the self-refresh mode to the normal display mode, the self-refresh unit performs a decompression procedure to progressively decompress the compression data and generate a plurality of second interval data accordingly, and the timing controller outputs the plurality of second interval data sequentially, wherein when the decompression procedure ends, the timing controller outputs the image data from the scalar.

From another perspective, the invention provides an operation method of a panel control device, wherein the panel control device includes a scalar and a timing controller, and the operation method of the panel control device includes: transmitting an image data for forming a display image through the scalar; keeping the timing controller in a normal display mode or switching the timing controller to a self-refresh mode according to a state of the display image; performing a compression procedure to progressively compress the image data and generate a plurality of first interval data accordingly when the timing controller switches to the self-refresh mode; outputting the plurality of first interval data sequentially; storing one of the plurality of first interval data to a memory in the timing controller as a compression data when the compression procedure ends; and outputting the compression data from the memory continuously.

In an embodiment of the invention, the operation method of the panel control device further includes: performing a decompression procedure to progressively decompress the compression data and generate a plurality of second interval data accordingly when the timing controller switches from the self-refresh mode to the normal display mode; outputting the plurality of second interval data sequentially; and outputting the image data from the scalar when the decompression procedure ends.

Based on the above, the panel control device and the operation method thereof in the embodiments of the invention progressively compress the image data and output the corresponding first interval data when the operation mode switches to the self-refresh mode. In this way, human eyes are unlikely to perceive an instant change of the display image occurring when the operation mode switches, and users' comfort of watching the display image is thereby improved.

In order to make the aforementioned features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a panel control device according to an embodiment of the invention.

FIG. 2 is a flowchart of an operation method of a panel control device according to an embodiment of the invention.

### DESCRIPTION OF EMBODIMENTS

To make contents of the invention more comprehensible, embodiments are described below as examples according to which the invention is feasible as a matter of fact. Moreover, elements/components/steps with identical reference numerals represent identical or similar parts in the drawings and embodiments.

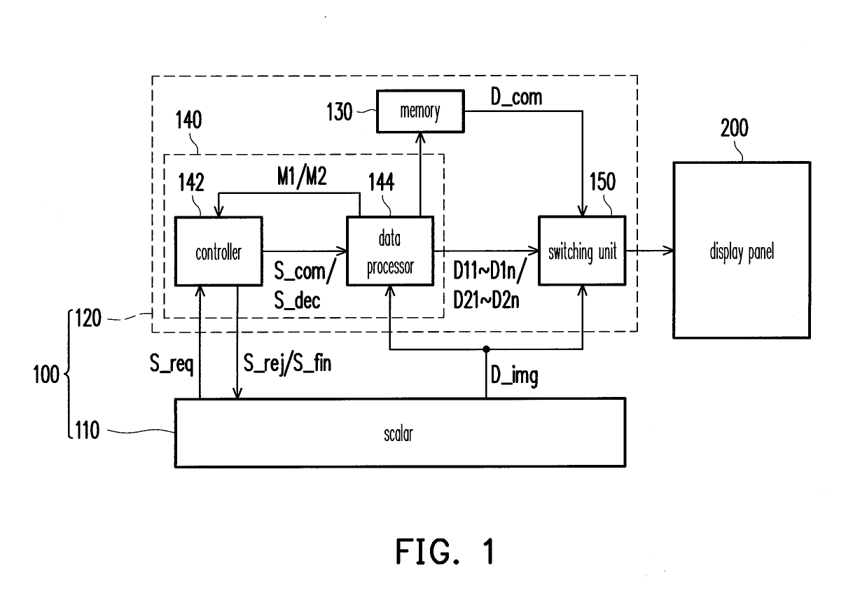

FIG. 1 is a schematic view illustrating a panel control device according to an embodiment of the invention. Please refer to FIG. 1. A panel control device 100 controls a display panel 200 and includes a scalar 110 and a timing controller 120. Herein, the scalar 110 transmits an image data D_img for forming a display image so that the display panel 200 displays a corresponding display image under the control of the panel control device 100.

The timing controller 120 includes a memory 130, a self-refresh unit 140, and a switching unit 150. Herein, the scalar 110 keeps the timing controller 120 in a normal display mode or switches the timing controller 120 to a self-refresh mode according to a state of the display image. In addition, when the timing controller 120 switches to the self-refresh mode, the self-refresh unit 140 performs a compression procedure to progressively compress the image data D_img and generate a plurality of first interval data D11-D1n accordingly. Therefore, while the self-refresh unit 140 is performing the compression procedure, the timing controller 120 outputs the first interval data D11-D1n to the display panel 200 correspondingly. In addition, when the compression procedure ends, the self-refresh unit 140 stores one of the first interval data D11-D1n to the memory 130 as a compression data D_com. At this time, the timing controller 120 outputs the compression data D_com from the memory 130 instead.

The switching unit 150 is electrically connected to the memory 130 and the self-refresh unit 140. In addition, the switching unit 150 is controlled by the self-refresh unit 140 to transmit data from the memory 130 or from the self-refresh unit 140, so that the display panel 200 displays a corresponding display image according to the first interval data D11-D1n and the compression data D_com sequentially.

In other words, the scalar 110 performs a motion detection on the display image of the display panel 200 to judge the state of the display image and keeps the timing controller 120 in the normal display mode or switches the timing controller 120 to the self-refresh mode accordingly. In detail, the scalar 110 decides whether to generate a refreshing request signal S_req according to the state of the display image. For example, when the display image is static, the scalar 110 generates the refreshing request signal S_req. At this time, the timing controller 120 receives the refreshing request signal S_req and switches from the normal display mode to the self-refresh mode. Furthermore, when the display image changes, the scalar 110 stops generating the refreshing request signal S_req, so that the timing controller 120 remains in the normal display mode or switches from the self-refresh mode to the normal display mode.

Based on the above, in contrast to a situation in which the timing controller 120 switches from the normal display mode to the self-refresh mode, when the timing controller 120 switches from the self-refresh mode to the normal display mode, the self-refresh unit 140 performs a decompression procedure to progressively decompress the compression data D_com and generate a plurality of second interval data D21-D2n accordingly. Therefore, while the self-refresh unit 140 is performing the decompression procedure, the timing controller 120 outputs the plurality of second interval data D12-D2n to the display panel 200 correspondingly. In addition, when the decompression procedure ends, the timing controller 120 outputs the image data D_img from the scalar 110.

Specifically, in the normal display mode, the timing controller 120 keeps outputting the image data D_img from the scalar 110, so that the display panel 200 displays the current display image according to the image data D_img. When switching to the self-refresh mode, the timing controller 120 outputs the first interval data D11-D1n first and then stores the compression data D_com to the memory 130. Afterwards, the timing controller 120 outputs the compression data D_com instead and the scalar 110 stops transmitting the image data D_img to save power consumption of the panel control device 100.

It should be noted that when the timing controller 120 switches the operation mode, i.e. when the timing controller 120 switches from the normal display mode to the self-refresh mode or switches from the self-refresh mode to the normal display mode, the timing controller 120 performs the corresponding compression procedure or decompression procedure according to a switching state of the operation mode and outputs the corresponding first interval data D11-D1n or the corresponding second interval data D21-D2n accordingly. Herein, the timing controller 120 uses a plurality of compression rates or decompression rates to progressively compress the image data D_img or decompress the compression data D_com. In this way, human eyes are unlikely to perceive an instant change of the display image occurring when the operation mode switches, and differences of the image quality perceived by human eyes are thereby eliminated.

Specifically, during an early stage when the timing controller 120 switches to the self-refresh mode, the scalar 110 does not stop transmitting the image data D_img immediately. In detailed operation, while performing the compression procedure, the self-refresh unit 140 transmits a rejection signal S_rej to the scalar 110, so that the scalar 110 keeps transmitting the image data D_img. In addition, when the compression procedure ends, the self-refresh unit 140 transmits a finish signal S_fin so that the scalar 110 stops transmitting the image data D_img. In this way, during the compression procedure is performed, the self-refresh unit 140 may be ensured to keep receiving the image data D_img from the scalar 110 and may thereby generate the first interval data D11-D1n.

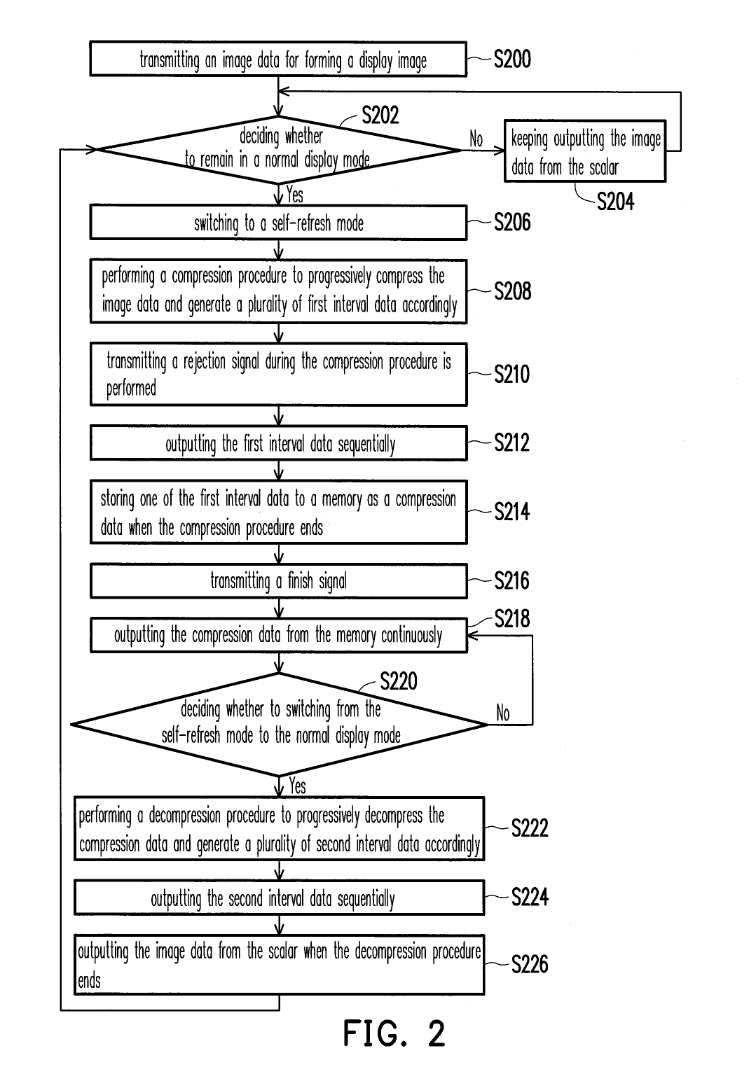

Furthermore, the self-refresh unit 140 includes a controller 142 and a data processor 144. In addition, FIG. 2 is a flowchart of an operation method of a panel control device according to an embodiment of the invention. The panel control device is further described below with reference to both FIGS. 1 and 2.

The panel control device 100 transmits the image data D_img for forming the display image through the scalar 110 (step S200) and decides whether to remain in the normal display mode according to the state of the display image (step S202).

In the step S202 of the present embodiment, the scalar 110 judges whether the display image is static as a basis of whether to generate the refreshing request signal S_req. In other words, when the scalar 110 judges that the display image changes, the scalar 110 stops generating the refreshing request signal S_req. At this time, the timing controller 120 remains in the normal display mode and keeps outputting the image data D_img from the scalar 110 (step S204). On the contrary, when the scalar 110 judges that the display image is static, the scalar 110 generates the refreshing request signal S_req to switch the timing, controller 120 to the self-refresh mode (step S206).

When the timing controller 120 switches to the self-refresh mode, the self-refresh unit 140 performs a compression procedure to progressively compress the image data D_img and generate the first interval data D11-D1n accordingly (step S208). In addition, during the compression procedure is performed, the self-refresh unit 140 transmits a rejection signal S_rej (step S210), so that the scalar 110 keeps transmitting the image data D_img. Herein, the steps S208 and S210 may be performed simultaneously and do not have to be performed in a determined order. Procedures of the present embodiment are an example embodiment, and the invention is not limited thereto.

In detail, when the timing controller 120 switches to the self-refresh mode, the controller 142 generates a compression signal S_com according to the refreshing request signal S_req. The data processor 144 thereby performs the compression procedure according to the compression signal S_com to progressively compress the image data D_img and generate the first interval data D11-D1n accordingly. Herein, the data processor 144 uses progressively increasing compression rates M1 such as compression rates of 1 time, 1.5 times and 2 times sequentially to progressively compress the image data D_img and generate the first interval data D11-D1n accordingly. In addition, during the compression of the image data D_img, the data processor 144 transmits the used compression rates M1 to the controller 142 simultaneously, so that the controller 142 decides whether to stop generating the compression signal S_com according to the compression rates M1.

Moreover, during the compression of the image data D_img, the switching unit 150 outputs correspondingly the first interval data D11-D1n generated by the data processor 144 (step S212). Furthermore, the controller 142 keeps judging the compression rates M1 transmitted thereto. Herein, when the controller 142 judges that the used compression rate M1 is equal to a predetermined compression rate, the controller 142 stops generating the compression signal S_com, so that the data processor 144 stops compressing the image data D_img and thereby ends the compression procedure.

When the compression procedure ends, the data processor 144 stores one of the first interval data D11-D1n to the memory 130 as the compression data D_com (step S214). In the present embodiment, the data processor 144 stores the first interval data (D1n, for example) obtained with the predetermined compression rate to the memory 130. In addition, when the compression procedure ends, the controller 142 also transmits a finish signal S_fin to the scalar 110 (step S216), so that the scalar 110 stops transmitting the image data D_img. Furthermore, at this time, the switching unit 150 continuously outputs the compression data D_com from the memory 130 to the display panel 200 instead (S218), so that the display panel 200 displays the image according to the compression data D_com.

After the timing controller 120 enters the self-refresh mode, the scalar 110 detects the state of the display image repeatedly and decides whether to switch the timing controller 120 from the self-refresh mode to the normal display mode according to the state of the display image (step S220). If the display image is still static, the timing controller 120 remains in the self-refresh mode and keeps outputting the compression data D_com from the memory 130.

In the step S220 of the present embodiment, when the scalar 110 judges that the display image changes, the scalar 110 stops generating the refreshing request signal S_req and makes the timing controller 120 switch back to the normal display mode. The self-refresh unit 140 thereby performs the decompression procedure to progressively decompress the compression data D_com and generate the second interval data D21-D2n accordingly (step S222).

Similar to the steps for performing the compression procedure, when the timing controller 120 switches from the self-refresh mode to the normal display mode, the controller 142 is unable to receive the refreshing request signal S_req and thereby generates the decompression signal S_dec. The data processor 144 thereby performs the decompression procedure according to the decompression signal S_dec. In detail, in contrast to the progressively increasing compression rates M1, the data processor 144 adjusts decompression rates M2 in a progressively decreasing order and uses the compression rates M2 to decompress the compression data D_com. The data processor 144 thereby generates the second interval data D21-D2n and outputs the second interval data D21-D2n to the switching unit 150.

For example, when the timing controller 120 switches to the self-refresh mode, the data processor 144 uses the compression rates M1 of 1.5 times, 2 times, and 2.5 times respectively to progressively compress the image data D_img and stops compressing the image data D_img when the compression rate M1 is 2.5 times, wherein the compression data D_com stored to the memory 130 is the image data D_img compressed with the compression rate M1 of 2.5 times. In such situation, when the timing controller 120 switches from the self-refresh mode to the normal display mode, the data processor 144 uses the decompression rates M2 of 2.5 times, 2 times, and 1.5 times sequentially to progressively decompress the compression data D_com, so that the compression data D_com is progressively decompressed to be the image data D_img.

In addition, similar to the compression procedure, while the data processor 144 is performing the decompression procedure, the data processor 144 transmits the decompression rates M2 to the controller 142 simultaneously, so that the controller 142 decides whether to stop generating the decompression signal S_dec according to the decompression rates M2. Moreover, during the decompression, the switching unit 150 outputs correspondingly the second interval data D21-D2n generated by the data processor 144 (step S224). Furthermore, the controller 142 keeps judging the transmitted decompression rates M2 thereto. Herein, when the controller 142 judges that the decompression rate M2 is a predetermined decompression rate, the controller 142 stops generating the decompression signal S_dec, so that the data processor 144 stops decompressing the compression data D_com to end the decompression procedure.

When the decompression procedure ends, the self-refresh unit 140 stops working, and the timing controller 120 outputs the image data D_img from the scalar 110 through the switching unit 150 (step S226). And then, the step S202 is performed to judge whether the timing controller 120 should remain in the normal display mode.

Based on the above, in operations of switching to the self-refresh mode and switching to the normal display mode, the panel control device and the operation method thereof described in the embodiments of the invention use progressive compression or decompression to insert corresponding interval data before and after the compression data is transmitted, so that human eyes are unlikely to perceive an instant change of the display image occurring when the operation mode switches, and users' comfort of watching the display image is thereby improved.

Although the invention has been disclosed by the above embodiments, the embodiments are not intended to limit the invention. It will be apparent to those skilled in the art that various modifications and variations can be made to the invention without departing from the spirit and scope of the invention. Therefore, the protecting range of the invention falls in the appended claims.

What is claimed is:

1. A panel control device comprising:
a scalar transmitting an image data for forming a display image; and
a timing controller, wherein the scalar keeps the timing controller in a normal display mode or switches the timing controller to a self-refresh mode according to a state of the display image, and the timing controller comprises:
a memory; and
a self-refresh unit, wherein when the timing controller switches to the self-refresh mode, the self-refresh unit performs a compression procedure to progressively compress the image data and generate a plurality of first interval data accordingly, and the timing controller outputs the plurality of first interval data sequentially, wherein when the compression procedure ends, the self-refresh unit stores one of the plurality of first interval data to the memory as a compression data, and the timing controller continuously outputs the compression data from the memory.

2. The panel control device according to claim 1, wherein during the compression procedure is performed, the self-refresh unit transmits a rejection signal so that the scalar keeps transmitting the image data, and when the compression procedure ends, the self-refresh unit transmits a finish signal so that the scalar stops transmitting the image data.

3. The panel control device according to claim 1, wherein when the timing controller remains in the normal display mode, the timing controller continuously outputs the image data from the scalar.

4. The panel control device according to claim 1, wherein the scalar further decides whether to switch the timing controller from the self-refresh mode to the normal display mode according to the state of the display image.

5. The panel control device according to claim 4, wherein when the timing controller switches from the self-refresh mode to the normal display mode, the self-refresh unit performs a decompression procedure to progressively decompress the compression data and generate a plurality of second interval data accordingly, and the timing controller outputs the plurality of second interval data sequentially, wherein when the decompression procedure ends, the timing controller outputs the image data from the scalar.

6. The panel control device according to claim 1, wherein the scalar judges whether the display image is static, and when the display image is static, the scalar generates a refreshing request signal to switch the timing controller to the self-refresh mode, and when the display image changes, the scalar stops generating the refreshing request signal to keep the timing controller in the normal display mode or to switch the timing controller from the self-refresh mode to the normal display mode.

7. The panel control device according to claim 6, wherein the self-refresh unit comprises:
a controller generating a compression signal when the timing controller switches to the self-refresh mode and generating a decompression signal when the timing controller switches from the self-refresh mode to the normal display mode; and
a data processor performing the compression procedure according to the compression signal to progressively compress the image data and generate the plurality of first interval data accordingly and transmitting a compression rate so that the controller decides whether to stop generating the compression signal according to the compression rate, wherein when the compression procedure ends, the data processor stores one of the plurality of first interval data to the memory as the compression data.

8. The panel control device according to claim 7, wherein the data processor further performs a decompression procedure according to the decompression signal to progressively decompress the compression data and generate the plurality of second interval data accordingly and transmitting a decompression rate so that the controller decides whether to stop generating the decompression signal according to the decompression rate.

9. The panel control device according to claim 7, wherein during the compression procedure is performed, the data processor further generates a rejection signal so that the scalar keeps transmitting the image data, and when the compression procedure ends, the data processor generates a finish signal so that the scalar stops transmitting the image data.

10. The panel control device according to claim 1, wherein the timing controller further comprises:
a switching unit electrically connected to the memory and the self-refresh unit and controlled by the self-refresh unit to transmit data from the memory or from the self-refresh unit.

11. An operation method of a panel control device, wherein the panel control device comprises a scalar and a timing controller, and the operation method of the panel control device comprises:
transmitting an image data for forming a display image through the scalar;
keeping the timing controller in a normal display mode or switching the timing controller to a self-refresh mode according to a state of the display image;
performing a compression procedure to progressively compress the image data and generate a plurality of first interval data accordingly when the timing controller switches to the self-refresh mode;
outputting the plurality of first interval data sequentially;
storing one of the plurality of first interval data to a memory in the timing controller as a compression data when the compression procedure ends; and
outputting the compression data from the memory continuously.

12. The operation method of the panel control device according to claim 11, further comprising:
transmitting a rejection signal so that the scalar keeps transmitting the image data during the compression procedure is performed; and
transmitting a finish signal so that the scalar stops transmitting the image data when the compression procedure ends.

13. The operation method of the panel control device according to claim 11, further comprising:
keeping outputting the image data from the scalar when the timing controller remains in the normal display mode.

14. The operation method of the panel control device according to claim 11, further comprising:
deciding whether to switch the timing controller from the self-refresh mode to the normal display mode according to the state of the display image.

15. The operation method of the panel control device according to claim 14, further comprising:
performing a decompression procedure to progressively decompress the compression data and generate a plurality of second interval data accordingly when the timing controller switches from the self-refresh mode to the normal display mode;
outputting the plurality of second interval data sequentially; and
outputting the image data from the scalar when the decompression procedure ends.
